(19) United States
(12) Patent Application Publication
(10) Pub. No.: US 2011/0043514 A1
(43) Pub. Date: Feb. 24, 2011

(54) METHOD AND APPARATUS FOR MULTIPLE DISPLAY SYNCHRONIZATION

(75) Inventors: Syed A. Hussain, Scarborough (CA); Jeffrey G. Cheng, Toronto (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC., Markham (CA)

(21) Appl. No.: 12/546,518

(22) Filed: Aug. 24, 2009

(51) Int. Cl. G09G 5/00

(52) U.S. Cl. 345/213

(57) ABSTRACT

A circuit includes a plurality of display path circuits and a timing and frame synchronization circuit. The timing and frame synchronization circuit aligns a first blanking interval of first timing information provided by a first of the display path circuits for a first display based on a second blanking interval of second timing information provided by a second of the display path circuits for a second display.

### FIELD

The present disclosure generally relates to display timing, and more particularly, to a method and apparatus for synchronizing timing of multiple displays.

### BACKGROUND

Applications employing multiple displays driven by multiple paths in order to present a single large surface distributed amongst the displays can exhibit difficulties when updating the surface due to inadequate timing and synchronization of the displays. For example, one of the displays may update its portion of the single large surface before one or more other displays. As such, the surface presented amongst the displays will have an artifact (e.g., tearing), which is undesirable.

FIG. 1 depicts an exemplary illustration of the aforementioned problem. An apparatus 100 is depicted at a first time 102, a second time 104, and a third time 106. The apparatus 100 includes a first display 108 and a second display 110. The first display 108 presents a first portion 112 of an image 114 in response to first display path information 116 from a first display path circuit 118 such as a graphics processing unit. Likewise, the second display 110 presents a second portion 120 of the image 114 in response to second display path information 122 from a second display path circuit 124.

A timing diagram of the first display path information 116 and the second display path information 122 is generally identified at 126. At time 102, the image 114 is presented by both displays 108, 110 as a rectangular shape, which is a correct representation of the surface to be displayed amongst the displays 108, 110. At time 128, the first display path information 116 begins a blanking interval (e.g., such as a vertical blanking interval). At time 130, the surface to be displayed is updated to a triangular shape. At time 132, the first and second display path circuits 118, 124 are programmed to flip to the updated surface (e.g., the triangular shape) during each path's respective blanking interval. At time 134, the second display path information 122 begins a blanking interval.

At time 136, the blanking interval of the second display path information 122 ends and the second display path information 122 provides a respective portion of the updated surface (e.g., the right side of the triangular shape) to the second display 100. In response thereto, the second display 120 presents the second portion 120 (e.g., the right side of the triangular shape) of the image 114 while the first display 108 continues to present the non-updated first portion 112 (e.g., the left side of the rectangular shape) of the image 114.

At time 138, the first display path information 138 begins a blanking interval, which ends at time 106. At time 106, the first display 108 presents the updated first portion 112 (e.g., the left side of the triangular shape) of the image 114. As such, during time period 104, the first display 108 presents the non-updated first portion 112 (e.g., left side of the rectangular shape) of the image 114 while the second display 110 simultaneously presents the updated second portion 120 (e.g., the right side of the triangular shape) of the image 114, which is undesirable.

Accordingly, a need exists for a method and apparatus that can drive multiple displays using multiple paths without the aforementioned problem.

### BRIEF DESCRIPTION OF THE DRAWINGS

The invention will be more readily understood in view of the following description when accompanied by the below figures, wherein like reference numerals represent like elements:

FIG. 1 is an exemplary illustration of the problems associated with the prior art;

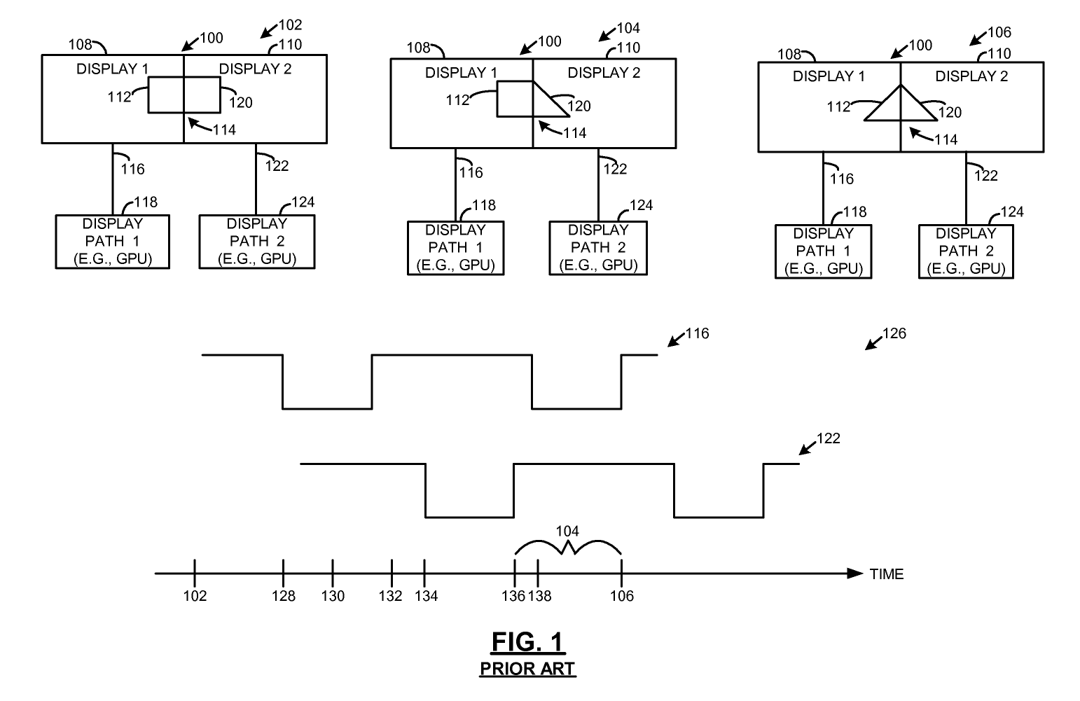

FIG. 2 is an exemplary functional block diagram of a device including multiple displays and multiple display path circuits;

FIG. 3 is an exemplary functional block diagram of a timing and frame synchronization circuit of the present disclosure;

FIG. 4 is an exemplary functional block diagram of one embodiment of the display path circuit;

FIG. 5 is an exemplary functional block diagram of another embodiment of the display path circuit;

FIG. 6 is a flowchart depicting exemplary operations that can be performed by the timing and frame synchronization circuit;

FIG. 7 is a flowchart depicting additional exemplary operations that can be performed by the timing and frame synchronization circuit; and

FIG. 8 is an exemplary illustration of the device operating with the timing and frame synchronization circuit.

### DETAILED DESCRIPTION

In one example, a circuit includes a plurality of display path circuits and a timing and frame synchronization circuit. The timing and frame synchronization circuit aligns a first blanking interval of first timing information provided by a first of the display path circuits for a first display based on a second blanking interval of second timing information provided by a second of the display path circuits for a second display. A related method is also disclosed.

The method and circuit provide, among other advantages, the ability to drive multiple displays using multiple paths without artifacts or tearing caused by one of the displays updating before the other. In addition, because the method and apparatus use one of the display paths as a reference to synchronize timing and frame updates, there is no need for additional external genlock and/or framelock circuits, which can reduce the size and cost of devices employing the circuit. Other advantages will be recognized by those of ordinary skill in the art.

In one example, the timing and frame synchronization circuit determines a page flip safe zone period based on a total of the plurality of display path circuits. The timing and frame synchronization circuit selectively programs the display path circuits to page flip based on the page flip safe zone period. More specifically, the timing and frame synchronization circuit programs the display path circuits to page flip in response to a blanking interval when a scan line count of a frame is within the page flip safe zone period. The timing and frame synchronization circuit delays programming of the display path circuits to page flip in response to a blanking interval until a scan line count of a frame within the page flip safe zone period.

In one example, a device includes the circuit. In another example, a computer readable medium includes information that when executed by a processor causes the processor to layout the circuit. In one example, the information comprises hardware description language.

The following description of the embodiments is merely exemplary in nature and is in no way intended to limit the invention, its application, or uses. For purposes of clarity, the same reference numbers will be used in the drawings to identify similar elements. As used herein, the term “apparatus,” “circuit,” and/or “device” can include an electronic circuit, one or more processors (e.g., shared, dedicated, or group of processors such as but not limited to microprocessors, DSPs, or central processing units) and memory that execute one or more software or firmware programs, combinational logic circuits, an ASIC, and/or other suitable components that provide the described functionality. Additionally, the term “signal” may refer to one or more currents, one or more voltages, or a data signal. Furthermore, as will be appreciated by those of ordinary skill in the art, the layout of a “apparatus,” “circuit,” and/or “device” can be described and laid out in a hardware description language such as Verilog™, VHDL, and/or other suitable hardware description languages.

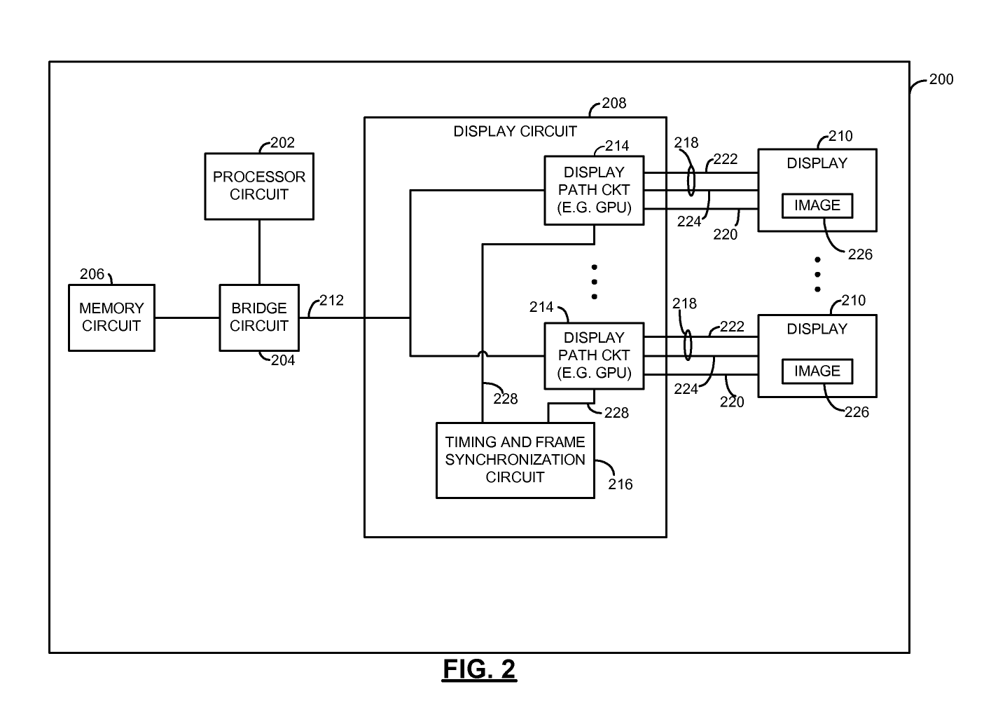

Referring now to FIG. 2, an exemplary functional block diagram of a device 200 such as a wireless phone, a mobile and/or stationary computer, a printer, a LAN interface (wireless and/or wired), a media player, a video decoder and/or encoder, and/or any other suitable device is depicted. The device 200 includes a processor circuit 202, a bridge circuit 204, a memory circuit 206, a display circuit 208, and a plurality of displays 210. In some embodiments, the displays 210 may be external to the device 200 if desired.

Although not depicted, in some embodiments, there may be six displays 210 aligned in a rectangular arrangement having three columns and two rows. As such, in this example, each of the displays 210 can present 1/6 of a frame so that the combination of all the displays 210 present the entire frame. Although six displays 210 are discussed in this example, it is contemplated that any number of displays 210 can be included and arranged as desired.

The processor circuit 202 is operatively coupled to the bridge circuit 204 and processes requests from the bridge circuit 204. The memory circuit 206 stores information communicated from the bridge circuit 204. The bridge circuit 204 communicates visual information 212 to the display circuit 208, which processes the information for presentation on the displays 210.

The display circuit 208 includes multiple display path circuits 214 and a timing and frame synchronization circuit 216. Exemplary display path circuits can include a graphics processing circuit, a video controller circuit (e.g., CRTC), and/or other suitable display path circuits. Each of the display path circuits 214 are operatively coupled to a respective one of the displays 210. The display path circuits 214 each provide timing information 218 and image information 220 to a respective display 210. The timing information 218 can include refresh rate information 222, blanking interval information 224, and/or other suitable timing information. Each of the displays 210 present a respective image 226 based on the timing information 218 and the image information 220. As noted above, each respective image 226 may be a portion of a large image surface so that when all images 226 are displayed, the entire large image surface is presented by all of the displays 210.

The timing and frame synchronization circuit 216 controls the display path circuits 214 via display path control signals 228 and the timing information 218 so that all of the displays 210 present the image 226 at substantially the same time. More specifically, the timing and frame synchronization circuit 216 adjusts the refresh rate information 222 so that all of the displays 210 are operating at the same refresh rate. In one embodiment, the timing and frame synchronization circuit 216 uses the refresh rate information 222 provided by one of the display path circuits 214 as a reference and adjusts the refresh rate of the other display path circuits 214 based thereon. In other embodiments, the timing and frame synchronization circuit 216 can set the refresh rate information 216 provided by all display paths 216 to a determined refresh rate such as a suitable commonly supported refresh rate or other suitable refresh rate.

The timing and frame synchronization circuit 216 also aligns blanking intervals of the timing information 218 for each of the displays 210. For example, in one embodiment, the timing and frame synchronization circuit 216 aligns a blanking interval of timing information 218 provided by one or more display paths 214 with a blanking interval of timing information 218 provide by another of the display paths 214. More specifically, the timing and frame synchronization circuit 216 aligns a blanking interval of the blanking interval information 224 provided by one or more display paths with a blanking interval of the blanking interval information 224 provided by another of the display paths 214. As a result, the blanking intervals of the timing information 218 provided to all of the displays 210 are substantially aligned. Therefore, each of the displays 210 begin its respective retrace sequence at substantially the same time and thus each frame of the image 226 is updated at substantially the same time.

In addition, as will be discussed in more detail below, the timing and frame synchronization circuit 216 determines when to program each of the display path circuits 214 to perform a page flip in order to prevent one of the displays 210 from updating its image 226 to the next frame before another of the displays 210 updates its image to the next frame. Page flipping uses two or more frame buffers such that new image information is written to a first buffer while a second buffer simultaneously provides previously written image information to a display. After a frame of image information has been written to the first buffer, it can provide the image information to the display while new image information is simultaneously being written to the second buffer. As such, the first and second buffers flip back and forth taking turns to provide the image information to the display. In this manner, page flipping can be used to prevent a frame buffer from providing image information to a display when a new frame is simultaneously being written to that frame buffer.

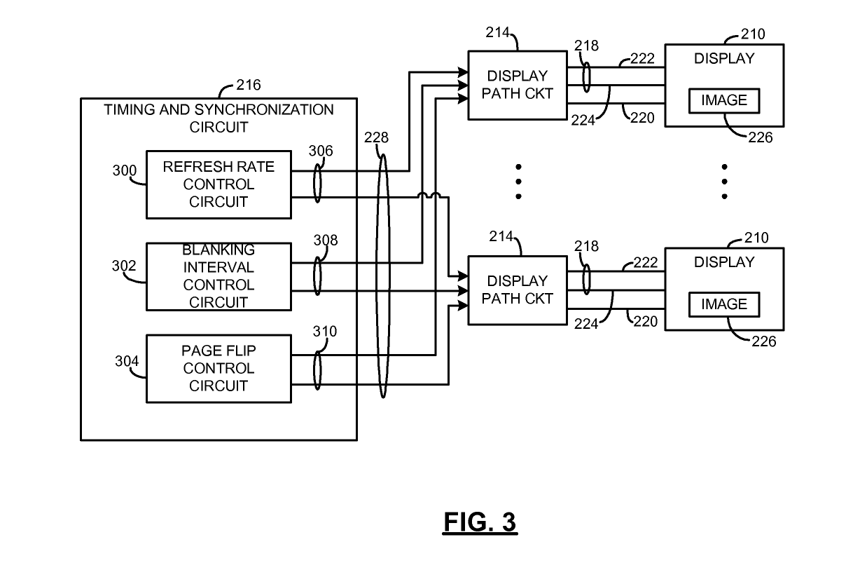

Referring now to FIG. 3, an exemplary functional block diagram of the timing and frame synchronization circuit 216 is depicted. The timing and frame synchronization circuit 216 includes a refresh rate control circuit 300, a banking interval control circuit 302, and a page flip control circuit 304. The refresh rate control circuit 300 provides refresh control information 306 to each of the display path circuits 214. In response to the refresh rate control information 306, each of the display path circuits 214 provides refresh rate information 222 having substantially the same refresh rate to each of the displays 210.

The blanking interval control circuit 302 provides blanking interval control information 308 to the display path circuits 214. In response to the blanking interval control information 308, the display path circuits 214 each provide the blanking interval information 224 having substantially aligned blanking intervals. More specifically, the blanking interval control circuit 302 can use the blanking interval information 224 of one of the display path circuits 214 as a reference to align the blanking interval of the other display path circuits 214 within a determined phase delta such as the amount of time required to scan one line or other suitable phase delta. In one embodiment, the blanking interval control circuit 302 can use the blanking interval of the reference blanking information 224 to trigger a reset of the other display path circuits 214. More specifically, the blanking interval control circuit 302 can use the blanking interval of the reference blanking information 224 to trigger a reset of a timing control circuit (not shown) associated with of the other display path circuits 214 in order to reset an associated line counter circuit (not shown). In another embodiment, the blanking interval control circuit 302 can use an interrupt handler call (e.g., a reset event) that is triggered at an appropriate scan line based on the reference path to reset the other display path circuits 214 in order to align the blanking interval to within an acceptable delta. In yet another embodiment, the blanking interval control circuit 302 can adjust a suitable timing parameter such as a vertical total, a horizontal total, one or more pixel clocks, and/or any other suitable timing parameter on a desired path for a frame based on a delta from the reference path so that a subsequent frame has phase delta that is within an acceptable range. In this example, the timing parameter is adjusted back to the actual value once the desired phase delta has been obtained. In still another embodiment, the other display path circuits 214 can be synchronized with the reference path's line counter in order to synchronize the respective blanking intervals.

The page flip control circuit 304 determines a page flip safe zone period to ensure that all of the display path circuits 214 are programmed to page flip prior to the blanking interval of the blanking interval information 224. The page flip safe zone is based on a total of how many display path circuits 214 need to be programmed to page flip. The page flip safe zone can also be based on various system load conditions such as processes and memory utilization, pending queues of tasks (e.g., high priority tasks), latencies associated with the page flipping process, and/or other suitable system load conditions.

The page flip control circuit 304 controls the display paths to page flip via the page flip control signal 310. More specifically, upon receiving surface ready notification (e.g., ready to display the next frame), the page flip control circuit 304 determines whether the scan line count on the reference path is within the page flip safe zone. If the line count is within the safe zone, the page flip control circuit 304 controls the display path circuits 214 to page flip during the next blanking interval (e.g., VSYNC). However, if the scan line count is not in the page flip safe zone (e.g., the un-safe zone), the page flip control circuit 304 can delay the page flip until the scan line count is in the page flip safe zone. For example, in one embodiment, the page flip control circuit 304 can set up a deferred notification by setting up an interrupt event that is generated when the scan line count on the reference path is in the page flip safe zone. In this embodiment, the deferred update interrupt event can then initiate the sequence of programming the display path circuits 214 for the page flip.

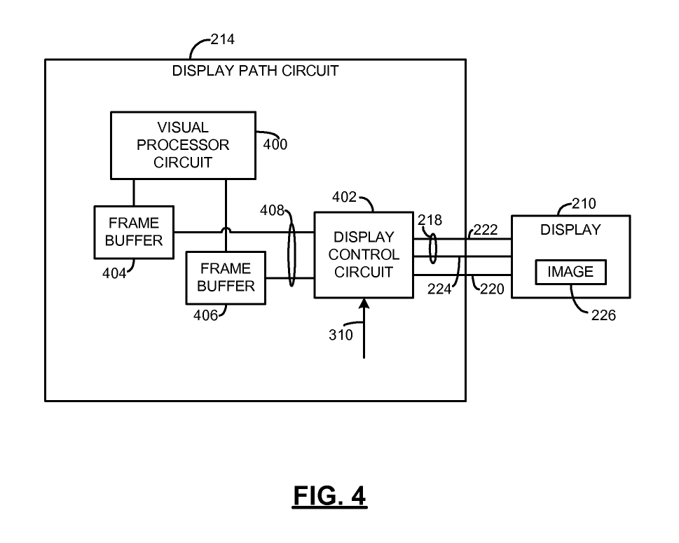

Referring now to FIG. 4, an exemplary functional block diagram of one embodiment of the display path circuits 214 is depicted. In this example, the display path circuits 214 include a visual processor circuit 400 (e.g., a graphics and/or video processing circuit), a display control circuit 402 (e.g., a CRTC or other suitable display control circuit), a first frame buffer circuit 404, and a second frame buffer circuit 406.

During operation, the visual processor circuit 400 writes frames (or portions of a larger surface frame) to one of the frame buffer circuits 404, 406 while the display control circuit 402 reads a frame (or portions of a larger surface frame) from the other frame buffer circuit 404, 406. More specifically, the display control circuit 402 selectively reads frame information 408 from the first frame buffer 404 or the second frame buffer 406 based on the page flip control signal 310, which ensures that all of the display path circuits 214 are programmed to page flip prior to the blanking interval of the blanking interval information 224.

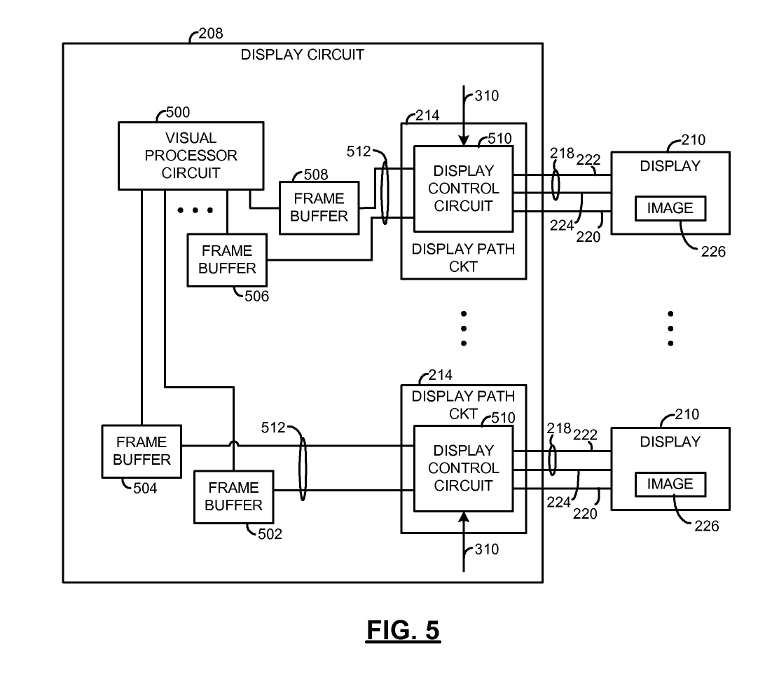

Referring now to FIG. 5, an exemplary functional block diagram of one embodiment of the display circuit 208 and the display path circuits 214 is depicted. In this example, the display circuit 208 includes a visual processor circuit 500 (e.g., a graphics and/or video processing circuit), a first frame buffer circuit 502, a second frame buffer circuit 502, a third frame buffer circuit 502, a fourth frame buffer circuit 502, and the display path circuits 214. In addition, each of the display path circuits 214 include a display control circuit 510 such as a CRT controller or other suitable display control circuit.

During operation, the visual processor circuit 500 writes frames (or portions of a larger surface frame) to one of the frame buffer circuits 502, 504 while the respective display control circuit 510 reads a frame (or portions of a larger surface frame) from the other frame buffer circuit 502, 504. Similarly, the visual processor circuit 500 writes frames (or portions of a larger surface frame) to one of the frame buffer circuits 506, 508 while the respective display control circuit 510 reads a frame (or portions of a larger surface frame) from the other frame buffer circuit 506, 508. More specifically, the respective display control circuit 510 selectively reads frame information 512 from the third frame buffer 506 or the fourth frame buffer 508 based on the page flip control signal 310, which ensures that that all of the display path circuits 214 are programmed to page flip prior to the blanking interval. Likewise, the respective display control circuit 510 selectively reads frame information 512 from the first frame buffer 502 or the second frame buffer 504 based on the page flip control signal 310, which ensures that that all of the display path circuits 214 are programmed to page flip prior to the blanking interval.

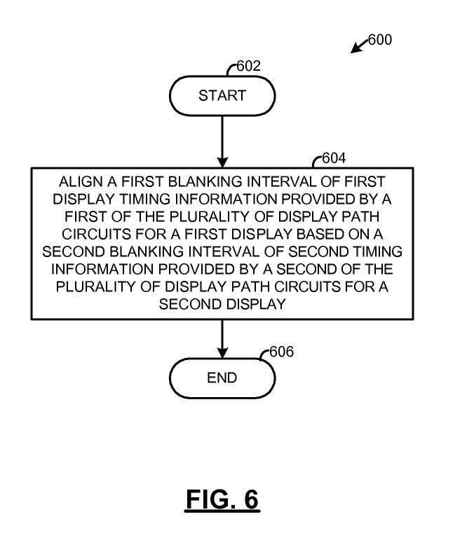

Referring now to FIG. 6, exemplary operations that can be performed by the timing and frame synchronization circuit 216 are generally identified at 600. The process starts 602. At 604, the timing and frame synchronization circuit 216 aligns a first blanking interval of the timing information 218 provided by a first of the display path circuits 214 for a first of the displays 210 based on a second blanking interval of the timing information 218 provided by a second of the display path circuits 214 for a second of the displays 210. The process ends at 606.

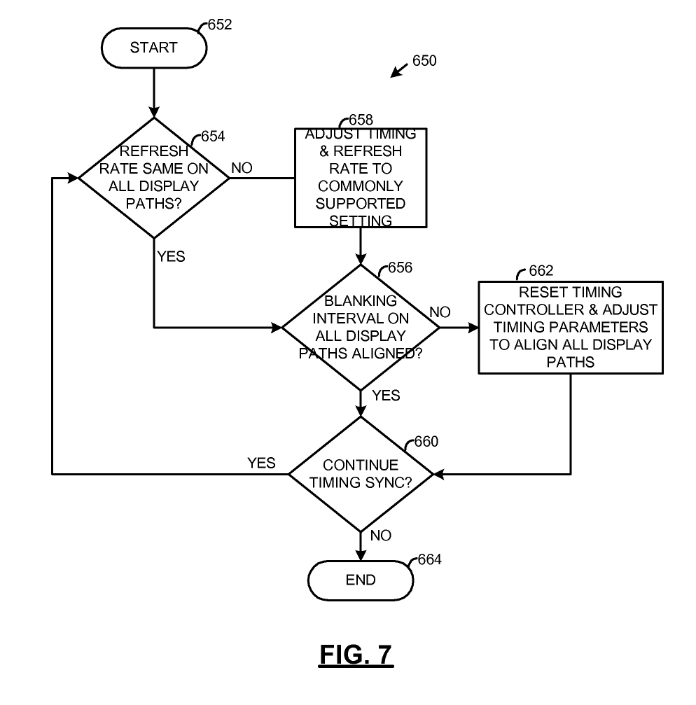

Referring now to FIG. 7, additional exemplary operations that can be performed by the timing and frame synchronization circuit 216 are generally identified at 650. The process starts at 652. At 654, the timing and frame synchronization circuit 216 determines whether the refresh rate information 222 provided by each of the display path circuits 214 are equal or substantially the same. If the refresh rate information 222 provided by each of the display path circuits 214 are equal or substantially the same, the process proceeds to 656. However, if the refresh rate information 222 provided by each of the display path circuits 214 are not equal or substantially the same, the timing and frame synchronization circuit 216 adjusts the refresh rate information 222 so that the refresh rate information 222 provided by each of the display path circuits 214 are equal or substantially the same at 658 and then proceeds to 656.

At 656, the timing and frame synchronization circuit 216 determines whether blanking intervals of the timing information 218 provided by each the display paths 214 are substantially aligned. If the blanking intervals of the timing information 218 provided by each the display paths 214 are not substantially aligned, process proceeds to 660. However, if the blanking intervals of the timing information 218 provided by each the display paths 214 are not substantially aligned, the timing and frame synchronization circuit 216 aligns the blanking intervals of the timing information 218 provided by each the display paths 214 at 662. More specifically, as noted above, timing and frame synchronization circuit 216 aligns a blanking interval provided by one or more display paths 214 with a blanking interval of timing information 218 provide by another of the display paths 214.

When the blanking intervals of the timing information 218 provided by each the display paths 214 are substantially aligned, the process proceeds to 660. At 660, the timing and frame synchronization circuit 216 determines whether to repeat or continue the timing and synchronization process. If the timing and frame synchronization circuit 216 determines to repeat the process, the process returns to 645. However, if the timing and frame synchronization circuit 216 determines not to repeat the process, the process proceeds to 664. The process ends at 664.

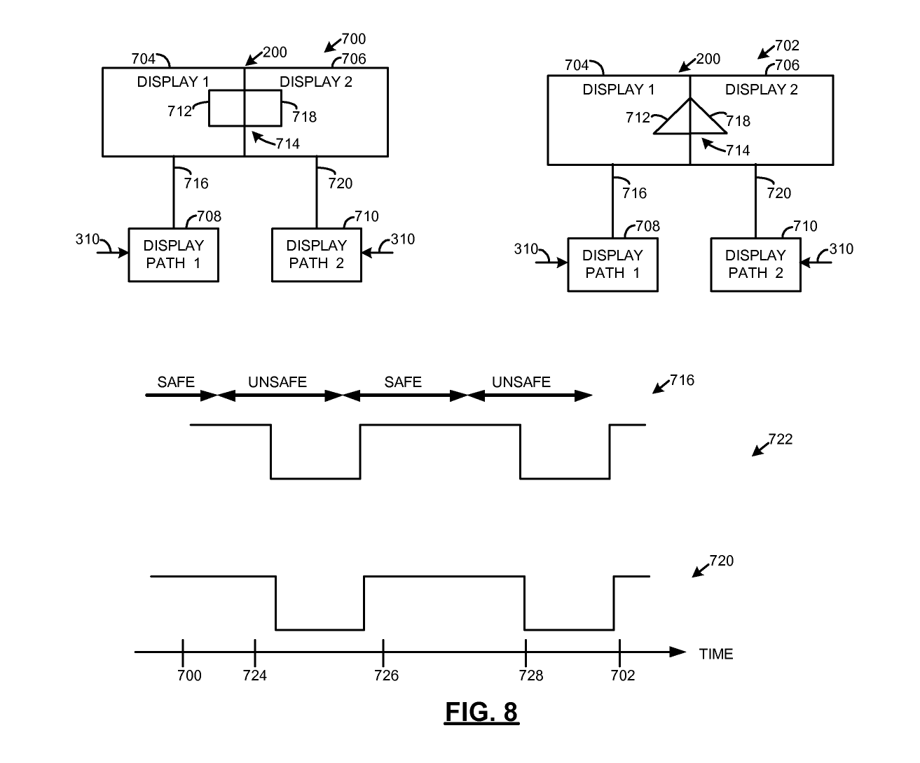

Referring now to FIG. 8, an exemplary illustration of the device 200 at a first time 700 and a second time 702 is depicted. In this example, the device 200 includes a first display 704, a second display 706, a first display path circuit 708, and a second display path circuit 710. The first display 704 presents a first portion 712 of an image 714 in response to first display path information 716 (e.g., timing information 218 and/or image information 220) from the first display path circuit 708. Likewise, the second display 706 presents a second portion 718 of the image 714 in response to second display path information 720 (e.g., timing information 218 and/or image information 220) from the second display path circuit 710.

A timing diagram of the first display path information 716 and the second display path information 720 is generally identified at 722. At time 700, the image 714 is presented by both displays 704, 706 as a rectangular shape, which is a correct representation of the surface to be displayed amongst the displays 704, 706. At time 724, the image 714 is to be updated. However, because the display path information 716, 720 is not in the safe zone, the display paths 708, 710 do not page flip to the updated image and wait until the display path information 716, 720 enters the safe zone. This ensures that both of the display path circuits 708, 710 are programmed to page flip during the same blanking interval. At time 726, the display path information 716, 720 enters the safe zone period and is programmed, via page flip control signal 310, to page flip during the next blanking interval. At time 728, the display path information 716, 720 enters the next blanking interval and performs a page flip. At time 702, the display path information 716, 720 exits the blanking interval and provides the updated image 714, which is now a triangular shape, to the displays 704, 706 for presentation. Accordingly, both portions 712, 718 of the image 714 are updated at substantially the same time, which can essentially eliminate any artifacts (or tearing) caused by one of the portions updating prior to the other.

As noted above, among other advantages, the method and apparatus provide, among other advantages, the ability to drive multiple displays using multiple paths without artifacts or tearing cause by one of the displays updating before the other. In addition, because the method and apparatus use one of the display paths as a reference to synchronize timing and frame updates, there is no need for additional external genlock and/or framelock circuits, which can reduce the size and cost of the apparatus. Other advantages will be recognized by those of ordinary skill in the art.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims. In addition, unless stated otherwise, terms such as “first” and “second” are used to arbitrarily distinguish between the elements such terms describe. Thus, these terms are not necessarily intended to indicate temporal or other prioritization of such elements. The term coupled, as used herein, is defined as connected, although not necessarily directly, and not necessarily mechanically. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms a or an, as used herein, are defined as one or more than one.

What is claimed is:

1. A circuit comprising:
a plurality of display path circuits; and
a timing and frame synchronization circuit that is operative to align a first blanking interval of first timing information provided by a first of the plurality of display path circuits for a first display based on a second blanking interval of second timing information provided by a second of the plurality of display path circuits for a second display.

2. The circuit of claim 1 wherein the timing and frame synchronization circuit is operative to determine a page flip safe zone period based on a total of the plurality of display path circuits.

3. The circuit of claim 2 wherein the timing and frame synchronization circuit is operative to selectively program the plurality of display path circuits to page flip based on the page flip safe zone period.

4. The circuit of claim 3 wherein the timing and frame synchronization circuit is operative to program the plurality of display path circuits to page flip in response to a blanking interval when a scan line count of a frame is within the page flip safe zone period.

5. The circuit of claim 3 wherein the timing and frame synchronization circuit is operative to delay programming of the plurality of display path circuits to page flip in response to a blanking interval until a scan line count of a frame is within the page flip safe zone period.

6. A method of synchronizing a plurality of display path circuits comprising aligning a first blanking interval of first display timing information provided by a first of the plurality of display path circuits for a first display based on a second blanking interval of second timing information provided by a second of the plurality of display path circuits for a second display.

7. The method of claim 6 further comprising determining a page flip safe zone period based on a total of the plurality of display path circuits.

8. The method of claim 7 further comprising selectively programming the plurality of display path circuits to page flip based on the page flip safe zone period.

9. The method of claim 8 further comprising programming the plurality of display path circuits to page flip in response to a blanking interval when a scan line count of a frame is within the page flip safe zone period.

10. The method of claim 9 further comprising delaying programming of the plurality of display path circuits to page flip in response to a blanking interval until a scan line count of a frame is within the page flip safe zone period.

11. An device comprising:
a plurality of display path circuits each for operatively coupling to one of a plurality of displays; and
a timing and frame synchronization circuit that is operative to align a first blanking interval of first timing information provided by a first of the plurality of display path circuits for a first of the plurality of displays based on a second blanking interval of second timing information provided by a second of the plurality of display path circuits for a second of the plurality of displays.

12. The device of claim 1 wherein the timing and frame synchronization circuit is operative to determine a page flip safe zone period based on a total of the plurality of display path circuits.

13. The device of claim 12 wherein the timing and frame synchronization circuit is operative to selectively program the plurality of display path circuits to page flip based on the page flip safe zone period.

14. The device of claim 13 wherein the timing and frame synchronization circuit is operative to program the plurality of display path circuits to page flip in response to a blanking interval when a scan line count of a frame is within the page flip safe zone period.

15. The device of claim 13 wherein the timing and frame synchronization circuit is operative to delay programming of the plurality of display path circuits to page flip in response to a blanking interval until a scan line count of a frame is within the page flip safe zone period.

16. A computer readable medium comprising information that when executed by at least one processor causes the at least one processor to configure the layout of a circuit that comprises:
a plurality of display path circuits; and
a timing and frame synchronization circuit that is operative to align a first blanking interval of first timing information provided by a first of the plurality of display path circuits for a first display based on a second blanking interval of second timing information provided by a second of the plurality of display path circuits for a second display.

17. The computer readable medium of claim 16 wherein the timing and frame synchronization circuit is operative to determine a page flip safe zone period based on a total of the plurality of display controllers.

18. The computer readable medium of claim 17 wherein the timing and frame synchronization circuit is operative to selectively program the plurality of display controller circuits to page flip based on the page flip safe zone period.

19. The computer readable medium of claim 18 wherein the timing and frame synchronization circuit is operative to program the plurality of display controller circuits to page flip in response to a blanking interval when a scan line count of a frame is within the page flip safe zone period.

20. The computer readable medium of claim 18 wherein the timing and frame synchronization circuit is operative to delay programming of the plurality of display controller circuits to page flip in response to a blanking interval until a scan line count of a frame is within the page flip safe zone period.
